(19) United States
(12) Patent Application Publication
(10) Pub. No.: US 2012/0278819 A1
(43) Pub. Date: Nov. 1, 2012

(54) POLLING-DRIVEN DEVICE DRIVER INTERFACE

(76) Inventor: Byungcheol Cho, Seochogu (KR)

(21) Appl. No.: 13/094,159

(22) Filed: Apr. 26, 2011

(51) Int. Cl. G06F 9/44

(52) U.S. Cl. 719/325

(57) ABSTRACT

Embodiments of the present invention provide a storage device (SSD) system architecture including a host comprising a device driver associated with a storage device and a central processing unit (CPU). The CPU is configured to request an input or output (I/O) operation of a storage device and begin polling the storage device via the device driver to determine whether the requested operation has been completed. The CPU begins its initial polling after waiting for a time interval equal to the storage device's predicted response time to elapse.

### CROSS-REFERENCE TO RELATED APPLICATION

This application is related in some aspects to commonly-owned, co-pending application Ser. No. 12/758,937, entitled SEMICONDUCTOR STORAGE DEVICE”, filed on Apr. 13, 2010.

### FIELD OF THE INVENTION

The present invention relates to a semiconductor storage device (SSD) based on a polling-driven device driver interface. Specifically, the present invention relates to a periodical polling-driven device driver interface for high-performance storage class memory.

### BACKGROUND OF THE INVENTION

As the need for more computer storage grows, more efficient solutions are being sought. As is known, there are various hard disk solutions that store/read data in a mechanical manner as a data storage medium. Unfortunately, data processing speed associated with hard disks is often slow. Moreover, existing solutions still use interfaces that cannot catch up with the data processing speed of memory disks having high-speed data input/output performance as an interface between the data storage medium and the host. Therefore, there is a problem in the existing area in that the performance of the memory disk cannot be property utilized.

### SUMMARY OF THE INVENTION

Embodiments of the present invention provide a semiconductor storage device (SSD) having a polling-driven device driver interface. Specifically, embodiments of the present invention provide a polling-driven device interface for high-performance storage class memory. The SSD system architecture includes a host comprising a device driver associated with a storage device and a central processing unit (CPU). The CPU is configured to request an input or output (I/O) operation of a storage device and begin polling the storage device via the device driver to determine whether the requested operation has been completed. The CPU begins its initial polling after waiting for a time interval equal to the storage device's predicted response time to elapse.

A first aspect of the present invention provides a semiconductor storage device (SSD) system architecture based on a polling-driven device driver interface, comprising: a storage device comprising a memory disk unit, the memory disk unit comprising a plurality of memory disks, each memory disk having a plurality of semiconductor memories; a host operably coupled to the storage device via an interface, the host comprising: a central processing unit (CPU) and a device driver associated with the storage device; wherein the CPU is configured to generate a requested operation; wherein the storage device is configured to execute the requested operation; wherein the device driver has the means for determining that the command has been completed by reading the status register of the device; and wherein the CPU is further configured to wait for a time interval based on the estimated response time of the device to elapse, then begin polling the storage device via the device driver to determine whether the requested operation has been completed and, if not completed, to continue polling until the requested operation is completed.

A second aspect of the present invention provides a method for providing a semiconductor storage device (SSD) system architecture based on a polling-driven device driver interface, comprising: providing a storage device comprising a memory disk unit, the memory disk unit comprising a plurality of memory disks, each memory disk having a plurality of semiconductor memories; providing a host operably coupled to the storage device via an interface, the host comprising: a central processing unit (CPU) and a device driver associated with the storage device; wherein the CPU is configured to generate a requested operation; wherein the storage device is configured to execute the requested operation; wherein the device driver has the means for determining that the command has been completed by reading the status register of the device; and wherein the CPU is further configured to wait for a time interval based on the estimated response time of the device to elapse, then begin polling the storage device via the device driver to determine whether the requested operation has been completed and, if not completed, to continue polling until the requested operation is completed.

A third aspect of the present invention provides a polling-driven device driver interface for a storage device, comprising: a storage device comprising a memory disk unit, the memory disk unit comprising a plurality of memory disks, each memory disk having a plurality of semiconductor memories; a host operably coupled to the storage device via an interface, the host comprising: a central processing unit (CPU) and a device driver associated with the storage device; wherein the CPU is configured to generate a requested operation; wherein the storage device is configured to execute the requested operation; wherein the device driver has the means for determining that the command has been completed by reading the status register of the device; and wherein the CPU is further configured to wait for a time interval based on the estimated response time of the device to elapse, then begin polling the storage device via the device driver to determine whether the requested operation has been completed and, if not completed, to continue polling until the requested operation is completed.

A fourth aspect of the present invention provides a method for providing a polling-driven device driver interface for a storage device, comprising: providing a storage device comprising a memory disk unit, the memory disk unit comprising a plurality of memory disks, each memory disk having a plurality of semiconductor memories; providing a host operably coupled to the storage device via an interface, the host comprising: a central processing unit (CPU) and a device driver associated with the storage device; wherein the CPU is configured to generate a requested operation; wherein the storage device is configured to execute the requested operation; wherein the device driver has the means for determining that the command has been completed by reading the status register of the device; and wherein the CPU is further configured to wait for a time interval based on the estimated response time of the device to elapse, then begin polling the storage device via the device driver to determine whether the requested operation has been completed and, if not completed, to continue polling until the requested operation is completed.

### BRIEF DESCRIPTION OF THE DRAWINGS

These and other features of this invention will be more readily understood from the following detailed description of the various aspects of the invention taken in conjunction with the accompanying drawings in which:

FIG. 1 is a diagram schematically illustrating a configuration of a storage device of a serial attached small computer system interface/serial advanced technology attachment (PCI-Express) type according to an embodiment of the present invention.

FIG. 2 is a diagram schematically illustrative a configuration of the high speed SSD of FIG. 1.

FIG. 3 is a diagram schematically illustrating a configuration of a controller unit in FIG. 1.

FIG. 4 is a diagram schematically illustrating an existing interrupt-driven device driver Interface.

FIG. 5 is a diagram schematically illustrating a polling-driven device driver interface.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Exemplary embodiments will now be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc. do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms such as those defined in commonly used dictionaries should be interpreted as having a meaning that is consistent with their meaning in the context of the relevant art and the present disclosure, and will not be interpreted in an idealized or overly formal sense unless expressly so defined herein.

As indicated above, embodiments of the present invention provide a semiconductor storage device having a polling-driven device driver interface. Specifically, embodiments of the present invention provide a polling-driven device interface for high-performance storage class memory. The SSD system architecture includes a host comprising a device driver associated with a storage device and a central processing unit (CPU). The CPU is configured to request an I/O operation of a storage device and begin polling the storage device via the device driver to determine whether the requested operation has been completed. The CPU begins its initial polling after waiting for a time interval equal to the storage device's predicted response time to elapse.

The storage device of an I/O standard such as a serial attached small computer system interface (SAS)/serial advanced technology attachment (SATA) type supports a low-speed data processing speed for a host by adjusting synchronization of a data signal transmitted/received between the host and a memory disk during data communications between the host and the memory disk through a PCI-Express interface, and simultaneously supports a high-speed data processing speed for the memory disk, thereby supporting the performance of the memory to enable high-speed data processing in an existing interface environment at the maximum. It is understood in advance that although PCI-Express technology will be utilized in a typical embodiment, other alternatives are possible. For example, the present invention could utilize SAS/SATA technology in which a SAS/SATA type storage device is provided that utilizes a SAS/SATA interface.

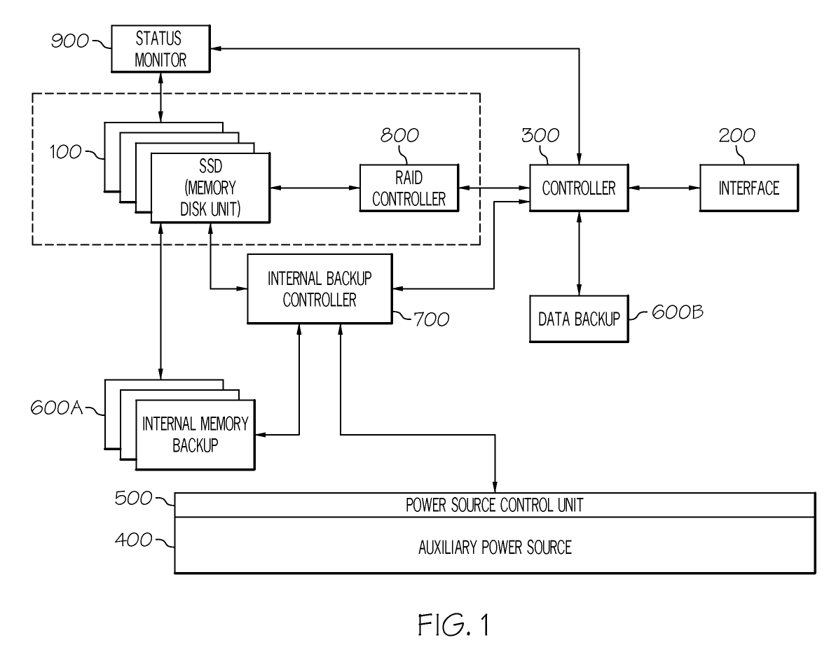

Referring now to FIG. 1, a diagram schematically illustrating a configuration of a PCI-Express type, RAID controlled storage device (e.g., for providing storage for a serially attached computer device) according to an embodiment of the invention is shown. As depicted, FIG. 1 shows a RAID controlled PCI-Express type storage device according to an embodiment of the invention which includes a memory disk unit 100 comprising: a plurality of memory disks having a plurality of volatile or non-volatile semiconductor memories (also referred to herein as high-speed SSDs 100); a RAID controller 800 coupled to SSDs 100; an interface unit 200 (e.g., PCI-Express host) which interfaces between the memory disk unit and a host; a controller unit 300; an auxiliary power source unit 400 that is charged to maintain a predetermined power using the power transferred from the host through the PCI-Express host interface unit; a power source control unit 500 that supplies the power transferred from the host through the PCI-Express host interface unit to the controller unit, the memory disk unit, the backup storage unit, and the backup control unit which, when the power transferred from the host through the PCI-Express host interface unit is blocked or an error occurs in the power transferred from the host, receives power from the auxiliary power source unit and supplies the power to the memory disk unit through the controller unit; a backup storage unit 600A-B that stores data of the memory disk unit; and a backup control unit 700 that backs up data stored in the memory disk unit in the backup storage unit, according to an instruction from the host or when an error occurs in the power transmitted from the host.

The memory disk unit 100 includes a plurality of memory disks provided with a plurality of volatile and non-volatile semiconductor memories for high-speed data input/output (for example, DDR, DDR2, DDR3, SDRAM, and the like), and inputs and outputs data according to the control of the controller 300. The memory disk unit 100 may have a configuration in which the memory disks are arrayed in parallel.

The PCI-Express host interface unit 200 interfaces between a host and the memory disk unit 100. The host may be a computer system or the like, which is provided with a PCI-Express interface and a power source supply device.

The controller unit 300 adjusts synchronization of data signals transmitted/received between the PCI-Express host interface unit 200 and the memory disk unit 100 to control a data transmission/reception speed between the PCI-Express host interface unit 200 and the memory disk unit 100.

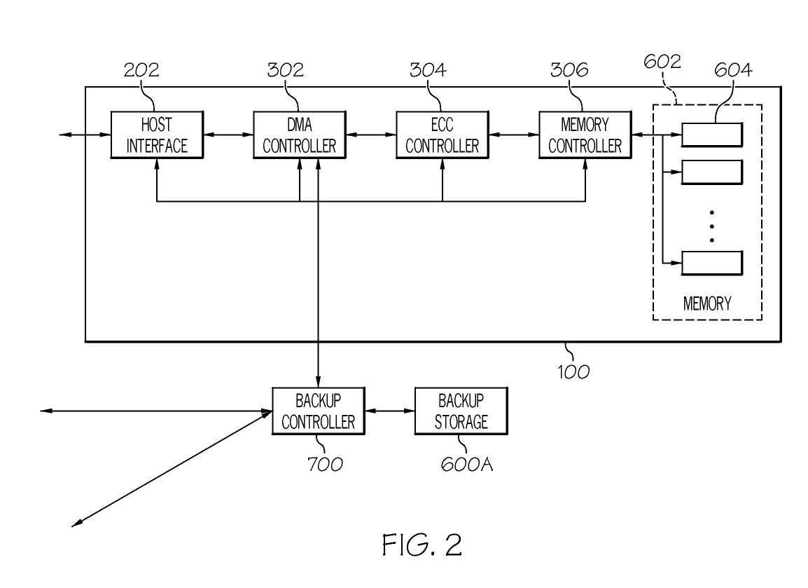

Referring now to FIG. 2, a diagram schematically illustrative a configuration of the high speed SSD 100 is shown. As depicted, SSD/memory disk unit 100 comprises a (e.g., PCI-Express host) host interface 202 (which can be interface 200 of FIG. 1, or a separate interface as shown), a DMA controller 302 interfacing with a backup control module 700, an ECC controller, and a memory controller 306 for controlling one or more blocks 604 of memory 602 that are used as high speed storage.

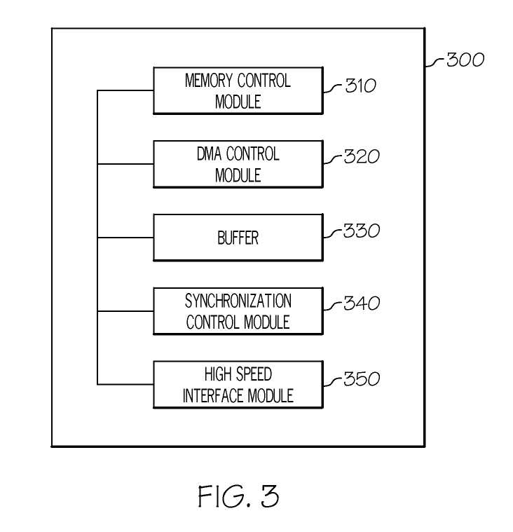

Referring now to FIG. 3, the controller unit 300 of FIG. 1 is shown as comprising: a memory control module 310 which controls data input/output of the SSD memory disk unit 100; a DMA control module 320 which controls the memory control module 310 to store the data in the SSD memory disk unit 100, or reads data from the SSD memory disk unit 100 to provide the data to the host, according to an instruction from the host received through the PCI-Express host interface unit 200; a buffer 330 which buffers data according to the control of the DMA control module 320; a synchronization control module 340 which, when receiving a data signal corresponding to the data read from the SSD memory disk unit 100 by the control of the DMA control module 320 through the DMA control module 320 and the memory control module 310, adjusts synchronization of a data signal so as to have a communication speed corresponding to a PCI-Express communications protocol to transmit the synchronized data signal to the PCI-Express host interface unit 200, and when receiving a data signal from the host through the PCI-Express host interface unit 200, adjusts synchronization of the data signal so as to have a transmission speed corresponding to a communications protocol (for example, PCI, PCI-x, or PCI-e, and the like) used by the SSD memory disk unit 100 to transmit the synchronized data signal to the SSD memory disk unit 100 through the DMA control module 320 and the memory control module 310; and a high-speed interface module 350 which processes the data transmitted/received between the synchronization control module 340 and the DMA control module 320 at high speed. Here, the high-speed interface module 350 includes a buffer having a double buffer structure and a buffer having a circular queue structure, and processes the data transmitted/received between the synchronization control module 340 and the DMA control module 320 without loss at high speed by buffering the data and adjusting data clocks.

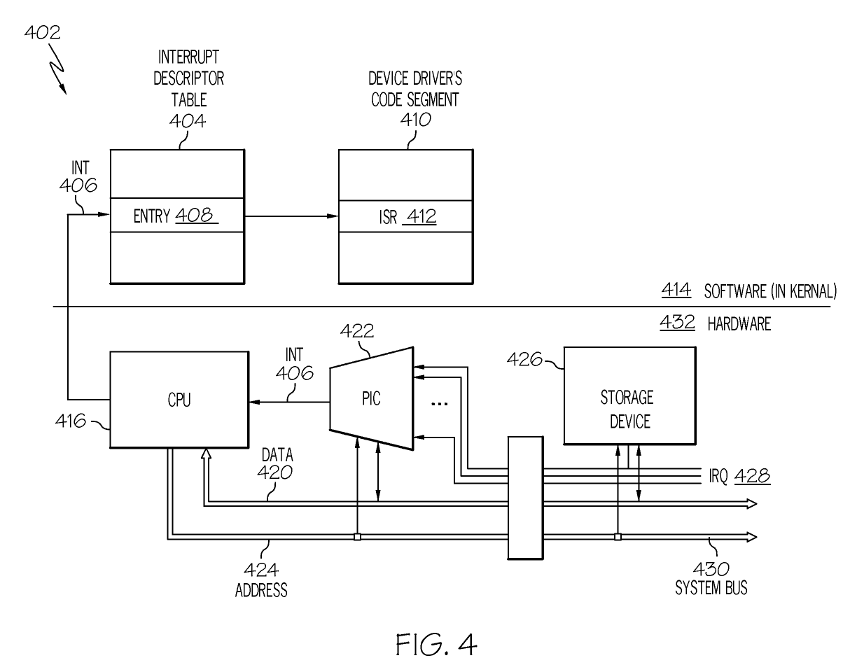

FIG. 4 is a diagram schematically illustrating an existing interrupt-driven device driver Interface. Communication between a processor and storage device is typically accomplished using interrupts. The storage device delivers an interrupt to the processor when it requires attention. For input, the storage device interrupts the processor when new data has arrived and ready to be retrieved by the processor. For output, the storage device interrupts the processor when it is ready to accept new data or acknowledge a successful data transfer. An overview of both the software (in kernel) 414 and hardware 432 components is depicted. Software 414 includes interrupt descriptor table 404 and code segment 410. Hardware 432 includes central processing unit (CPU) 416, programmable interrupt controller (PIC) 422, storage device 426, and system bus 430. System bus 430 connects CPU 416 and storage device 426. System bus 430 includes the data bus and address bus. The data bus is used to transfer data 420 between subunits, while the address bus is used to transmit location information (address) 424 relating to data 420. Interrupt request lines connect storage device 426 and PIC 422.

Storage device 426 intermittently receives data, which must be serviced by the processor. Storage device 426 interrupts CPU 416 when it has data. An interrupt is the temporary stopping of a current program routine in order to execute some higher priority I/O (input/output) subroutine. For example, storage device 426 receives data and sends IRQ 428 to PIC 422. PIC 422 evaluates the request and sends INT 406 to CPU 416. Interrupt descriptor table (IDT) 404 is a data structure used by CPU 416 to determine how to handle interrupt requests. IDT 404 is an array specifying interrupt service routines (ISRs). INT 406 maps to entry 408 in IDT 404. Entry 408 tells where the appropriate ISR (in this case, ISR 412) is located. ISR 412 is within device driver's code segment 410. ISR 412 is an executable code triggered by the reception of an interrupt. The data is then serviced by the processor. Several problems may affect interrupt-driven interfaces including context switching, low interrupt priority levels, critical regions, and livelock.

Each interrupt temporarily stops the execution of a current program routine in order to execute some higher priority I/O subroutine before returning to the original program routine. The act of switching from one task to another is called context switching. Context switching adds overhead to the computing process. To ensure that the original program routine does not lose any of its progress, the current state of the CPU is saved to memory before switching to the new subroutine. When switching back to the original program, the state of the CPU must first be loaded from memory.

Storage devices may be assigned a low interrupt priority level (IPL) compared to other system devices. Pending interrupts are processed in the order of their priority level. An interrupt request for a storage device is accepted if a higher level interrupt is not in progress. The delay in processing the interrupt request of the storage device may affect performance.

A critical region is a section of code during whose execution interrupts are to be ignored. The point of critical regions in your code is to ensure operations like database updates which, once started, must be completed in order to avoid an inconsistent state. The technique is used to protect any critical regions of code so they are not interrupted by a signal, but the number and length of critical regions may increase interrupt latency.

Still another potential issue with interrupt-driven interfaces is livelock. The condition resembles deadlock in that the system spends all its time processing interrupts, to the exclusion of other necessary tasks. Under extreme conditions, no packets are delivered to the user application or the output of the system.

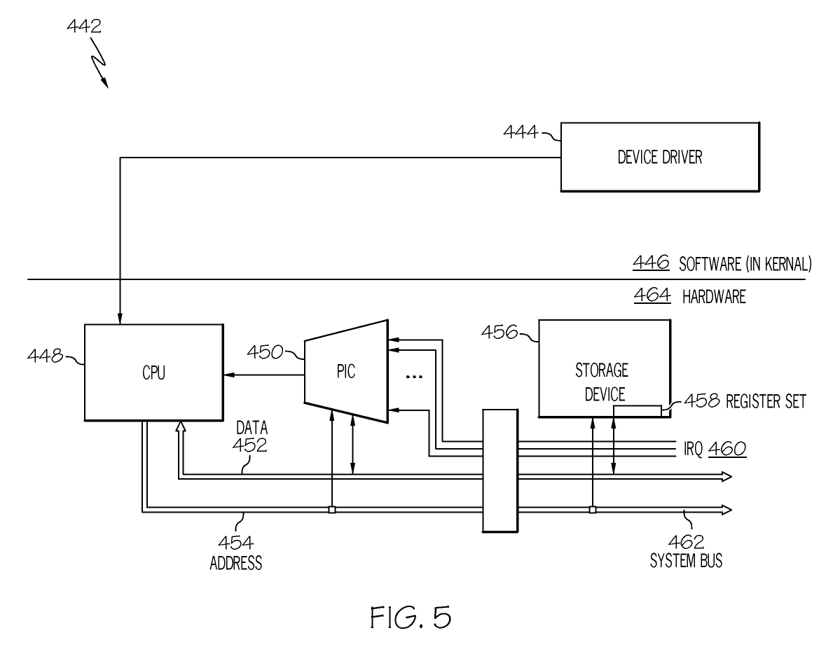

Referring now to FIG. 5, a diagram schematically illustrating a polling-driven device driver interface for high-performance storage class memory is shown. An overview of both the software (in kernel) 446 and hardware 464 components is depicted. Software 446 includes device driver 444. A device driver is a kernel module that is coded to communicate with a particular device. The device driver supports a standard set of operations. Each type of device may implement these operations differently. Hardware 446 includes central processing unit (CPU) 448, programmable interrupt controller (PIC) 450, storage device 456, and system bus 462. System bus 462 connects CPU 448 and storage device 456. System bus 462 includes the data bus and address bus. Data bus is used to transfer data 452 between subunits, while the address bus is used to transmit location information (address) 454 relating to data 452. Interrupt request lines connect storage device 456 and PIC 450. Storage device 456 includes register set 458.

Also referring to FIG. 5, device driver 444 disables the delivery of interrupts for storage device 456. CPU 448 requests an I/O operation be performed by storage device 456. CPU 448 polls status register 458 of storage device 456 via the device driver interface periodically for completion of requested I/O operation. The status register indicates that the device is ready for a command, has a response available, or is expecting more data.

To determine when to begin polling status register 458, the processor utilizes a predicted response time of storage device 456 and sleeps until the predicted response time has elapsed (yielding CPU time). After waking up, the processor begins polling and continues polling until the requested I/O operation has been completed. A response time table resides in the device driver (block). The response time of storage device 456 is initially calculated based on the block size of the storage device. The table is continuously updated during the operation based on previous actual response times of the device in order to calculate a more accurate predicted value.

The polling-driven device driver interface is used to facilitate high-performance storage class memory (SCM) in one embodiment of the present invention. SCM is an emerging technology that is a hybrid of flash and hard disk technology in which solid state drives are arranged in an array and accessed directly as a semiconductor chip. SCMs promise to be fast, inexpensive, and power efficient.

Referring back to FIG. 1, auxiliary power source unit 400 may be configured as a rechargeable battery or the like, so that it is normally charged to maintain a predetermined power using power transferred from the host through the PCI-Express host interface unit 200 and supplies the charged power to the power source control unit 500 according to the control of the power source control unit 500.

The power source control unit 500 supplies the power transferred from the host through the PCI-Express host interface unit 200 to the controller unit 300, the memory disk unit 100, the backup storage unit 600A-B, and the backup control unit 700.

In addition, when an error occurs in a power source of the host because the power transmitted from the host through the PCI-Express host interface unit 200 is blocked, or the power transmitted from the host deviates from a threshold value, the power source control unit 500 receives power from the auxiliary power source unit 400 and supplies the power to the memory disk unit 100 through the controller unit 300.

The backup storage unit 600A-B is configured as a low-speed non-volatile storage device such as a hard disk and stores data of the memory disk unit 100.

The backup control unit 700 backs up data stored in the memory disk unit 100 in the backup storage unit 600A-B by controlling the data input/output of the backup storage unit 600A-B and backs up the data stored in the memory disk unit 100 in the backup storage unit 600A-B according to an instruction from the host, or when an error occurs in the power source of the host due to a deviation of the power transmitted from the host deviates from the threshold value.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

The present invention supports a low-speed data processing speed for a host by adjusting synchronization of a data signal transmitted/received between the host and a memory disk during data communications between the host and the memory disk through a PCI-Express interface and simultaneously supports a high-speed data processing speed for the memory disk, thereby supporting the performance of the memory to enable high-speed data processing in an existing interface environment at the maximum.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A semiconductor storage device (SSD) system architecture based on a polling-driven device driver interface, comprising:
a storage device comprising a memory disk unit, the memory disk unit comprising a plurality of memory disks, each memory disk having a plurality of semiconductor memories;
a host operably coupled to the storage device via an interface, the host comprising: a central processing unit (CPU) and a device driver associated with the storage device;
wherein the CPU is configured to generate a requested operation;
wherein the storage device is configured to execute the requested operation;
wherein the device driver has the means for determining that the command has been completed by reading the status register of the device; and
wherein the CPU is further configured to wait for a time interval based on the estimated response time of the device to elapse, then begin polling the storage device via the device driver to determine whether the requested operation has been completed and, if not completed, to continue polling until the requested operation is completed.

2. The data storage architecture of claim 1, wherein the storage device is arranged in an array and accessed directly as a semiconductor chip.

3. The data storage architecture of claim 1, further comprising a table configured to store a value representing the estimated response time of the device, wherein the CPU is further configured to retrieve the value from the table and use the value as the time interval.

4. The data storage architecture of claim 3, wherein the table value is dynamically updated based on at least one actual response time of the device.

5. The data storage architecture of claim 1, wherein the device driver is configured to disable interrupt requests for the device.

6. A method for providing a semiconductor storage device (SSD) system architecture based on a polling-driven device driver interface, comprising:
providing a storage device comprising a memory disk unit, the memory disk unit comprising a plurality of memory disks, each memory disk having a plurality of semiconductor memories;
providing a host operably coupled to the storage device via an interface, the host comprising: a central processing unit (CPU) and a device driver associated with the storage device;
wherein the CPU is configured to generate a requested operation;
wherein the storage device is configured to execute the requested operation;
wherein the device driver has the means for determining that the command has completed by reading the status register of the device; and
wherein the CPU is further configured to wait for a time interval based on the estimated response time of the device to elapse, then begin polling the storage device via the device driver to determine whether the requested operation has been completed and, if not completed, to continue polling until the requested operation is completed.

7. The method of claim 6, wherein the storage device is arranged in an array and accessed directly as a semiconductor chip.

8. The method of claim 6, further comprising providing a table configured to store a value representing the estimated response time of the device, wherein the CPU is further configured to retrieve the value from the table and use the value as the time interval.

9. The method of claim 8, wherein the table value is dynamically updated based on at least one actual response time of the device.

10. The method of claim 6, wherein the device driver is configured to disable interrupt requests for the device.

11. A polling-driven device driver interface for a storage device, comprising:
a storage device comprising a memory disk unit, the memory disk unit comprising a plurality of memory disks, each memory disk having a plurality of semiconductor memories;
a host operably coupled to the storage device via an interface, the host comprising: a central processing unit (CPU) and a device driver associated with the storage device;
wherein the CPU is configured to generate a requested operation;
wherein the storage device is configured to execute the requested operation;
wherein the device driver has the means for determining that the command has completed by reading the status register of the device; and
wherein the CPU is further configured to wait for a time interval based on the estimated response time of the device to elapse, then begin polling the storage device via the device driver to determine whether the requested operation has been completed and, if not completed, to continue polling until the requested operation is completed.

12. The polling-driven device driver interface of claim 11, wherein the storage device is arranged in an array and accessed directly as a semiconductor chip.

13. The polling-driven device driver interface of claim 11, further comprising a table configured to store a value representing the estimated response time of the device, wherein the CPU is further configured to retrieve the value from the table and use the value as the time interval.

14. The polling-driven device driver interface of claim 13, wherein the table value is dynamically updated based on at least one actual response time of the device.

15. The polling-driven device driver interface of claim 11, wherein the device driver is configured to disable interrupt requests for the device.

16. A method for providing a polling-driven device driver interface for a storage device, comprising:
providing a storage device comprising a memory disk unit, the memory disk unit comprising a plurality of memory disks, each memory disk having a plurality of semiconductor memories;
providing a host operably coupled to the storage device via an interface, the host comprising: a central processing unit (CPU) and a device driver associated with the storage device;
wherein the CPU is configured to generate a requested operation;
wherein the storage device is configured to execute the requested operation;
wherein the device driver has the means for determining that the command has completed by reading the status register of the device; and
wherein the CPU is further configured to wait for a time interval based on the estimated response time of the device to elapse, then begin polling the storage device via the device driver to determine whether the requested operation has been completed and, if not completed, to continue polling until the requested operation is completed.

17. The method of claim 6, wherein the storage device is arranged in an array and accessed directly as a semiconductor chip.

18. The method of claim 6, further comprising providing a table configured to store a value representing the estimated response time of the device, wherein the CPU is further configured to retrieve the value from the table and use the value as the time interval.

19. The method of claim 8, wherein the table value is dynamically updated based on at least one actual response time of the device.

20. The method of claim 6, wherein the device driver is configured to disable interrupt requests for the device.
